(19) United States
(12) Patent Application Publication
(10) Pub. No.: US 2001/0029578 A1
(43) Pub. Date: Oct. 11, 2001

(54) Computer farm with a system for transferring files between processor cards

(76) Inventor: Hugo Delchini, Paris (FR)

Correspondence Address: Robert W. Bergstrom, Summit Law Group PLLC, Suite 300, 1505 Westlake Ave. N., Seattle, WA, 98109, US

(21) Appl. No.: 09/728,218

(22) Filed: Nov. 30, 2000

(30) Foreign Application Priority Data
Apr. 5, 2000 (FR) FR0004363

(51) Int. Cl. G06F 9/24

(52) U.S. Cl. 713/2

(57) ABSTRACT

The invention relates to a computer farm comprising a bus (7) and several processor cards (3a-3h) mounted on the bus, each processor card executing an operating system able to manage external system modules by way of drivers.

The farm includes means (12) for writing, to a processor card (3a), an operating system, a client part of file transfer software, a manager of external modules and software for appending external system modules, means (12) for remotely starting the operating system of the processor card, a server part (13) of the file transfer software for dispatching to the processor card, when requested by the client part when it is executed on said processor card, an external system module to be executed on the processor card.

The present invention relates to a computer farm with a system for transferring files between processor cards.

Computer clusters are known, these being computer-based infrastructures consisting of a large number of computers operating simultaneously and exchanging data with one another.

These clusters are for example used to offer Internet access to individuals.

One of the problems which arise with clusters is their footprint, and this is why the solution consisting in gathering together within one and the same box several computers linked by a bus has already been proposed.

One then speaks of a farm of computers.

In a farm, each computer is embodied by a processor card which executes its own operating system, as well as a certain number of items of application software.

Although the computer farms proposed hitherto do actually make it possible to reduce the amount of space occupied by the cluster, owing to the fact that a single farm replaces six or eight independent computers, the maintenance of each processor card of the farm is nevertheless complex, especially as regards updating the software items which it contains.

For example, in the particular case of a computer farm in which a local network is simulated on the bus, the operating system of each processor card incorporates a local network simulator module, and with each revision of this simulator, it is essential for the updating of the modules to be carried out on all of the processor cards of the farm, so that the network is correctly simulated and so that all the cards can exchange data packets of network type between one another.

A difficulty then arises, since each card must be updated individually according to its own configuration and that of the operating system which it hosts.

These updates require numerous manipulations and are possible causes of malfunctioning of the network.

The present invention aims to provide a solution to this problem of the individual updating of the processor cards.

The subject of the present invention is a computer farm comprising a bus and several processor cards mounted on the bus, each processor card executing an operating system able to manage external system modules by way of drivers, which farm includes:

means for writing, in a memory of at least one processor card, an operating system, a client part of a file transfer software, a manager of external modules and software for appending external system modules, this appending software being written as first program to be executed by the operating system upon startup thereof and having as tasks to start the client part of the file transfer software so as to download a system module, then to start the external modules manager so as to insert said downloaded module into the operating system,

means for remotely starting the operating system of the processor card,

a server part of the file transfer software for dispatching to the processor card, when requested by the client part when it is executed on said processor card, an external system module to be executed on the processor card.

In particular, when the computer farm simulates a local network on the bus, the invention makes it possible to download into each card not only the operating system required for the operation of the card but also an external system module for simulating the local network.

In this case, the writes to the memory of the card of the operating system, of the appending software and of the modules manager are performed by bus write cycles which are independent of the simulation of the network.

All the external system modules being identical, the updating of all the cards is performed very easily.

The simulation of the network is thus performed on each card by virtue of the network simulation module incorporated into the operating system by virtue of the external module manager.

The present invention applies in particular to buses of the PCI or CompactPCI type on which are simulated local networks of Ethernet type.

With the aim of providing a clearer understanding of the invention, an embodiment thereof given by way of a nonlimiting example will now be described with reference to the appended drawing in which:

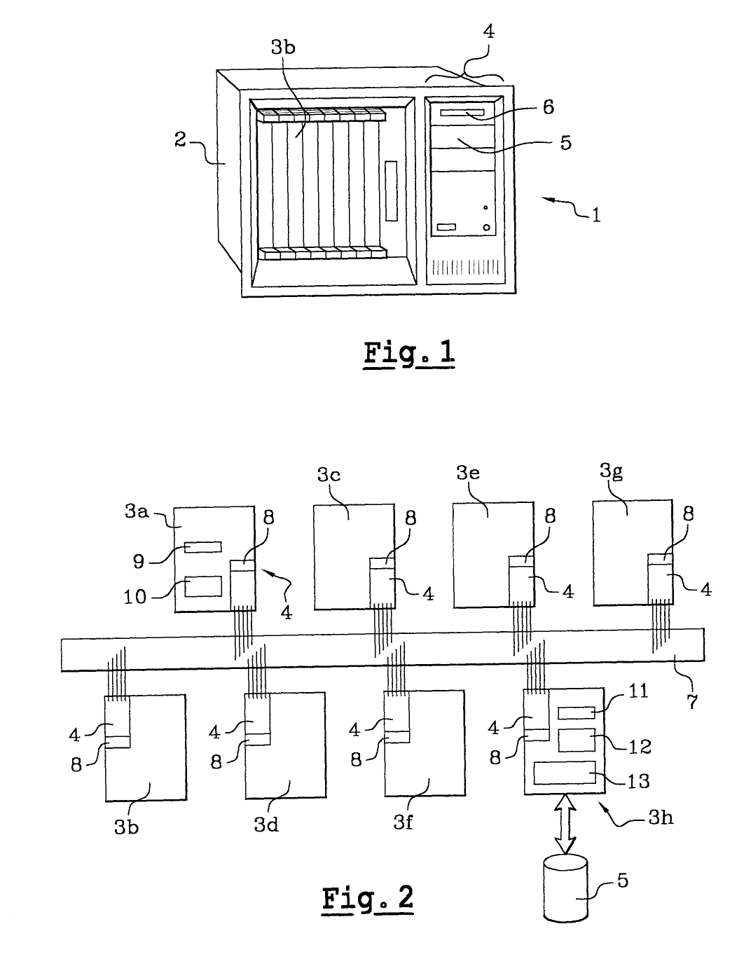

FIG. 1 is a three-quarter perspective front view of a computer farm according to the invention;

FIG. 2 is a diagrammatic view of a bus and of an assembly of processor cards mounted on this bus,

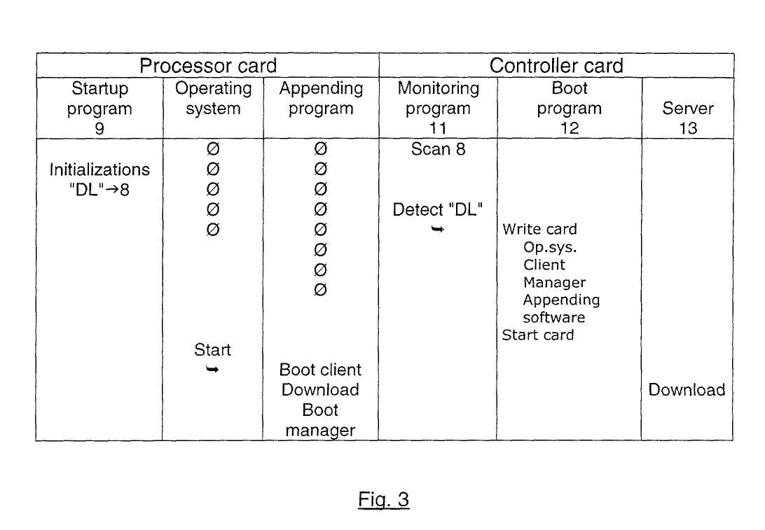

FIG. 3 is a chart illustrating the operations executed upon a request to transfer a file between two cards.

The farm 1 represented in the drawing comprises a box 2 which accommodates a bus (not visible in this figure) on which are mounted eight processor cards 3a-3h.

The farm comprises a compartment 4 containing a supply assembly and mass memories consisting in particular of a hard disk 5, as well as a CD ROM drive 6.

The bus 7 is diagrammatically represented in FIG. 2, in which it may be seen that the processor cards 3a-3h communicate with the bus by way of bridges 4, the data exchanges between the processor cards 3a-3h being performed by read and write cycles on the bus 7.

Each bridge 4 contains registers, just one of which is represented here and will be referred to as the state register 8 in the subsequent description.

In the example described, the card 3h plays the role of controller card. It monitors the state of the other cards and undertakes the management of the farm, in particular on the occurrence of an event relating to the powering-up of any one of the other cards, to its resetting or to its extraction from the farm.

For the clarity of the drawing, only the details of the card 3a and of the controller card 3h will be described. The other cards 3b to 3g are identical to the card 3a, at least as regards the characteristics which will be described. The cards 3a to 3g may nevertheless be distinguished through other characteristics unconnected with the present invention.

The card 3a comprises, on the one hand, a nonvolatile memory 9, for example a read only memory (ROM), containing a startup program which is executed when the card is powered up.

Moreover, the card 3a comprises a random access memory 10, intended to contain downloaded files as will be described.

The controller card 3h contains a program 11 for monitoring the state registers 8 of all the other cards 3a to 3g, a program 12 for booting said other cards, as well as a server part 13 of an item of file transfer software, which is able, when requested by a card, to dispatch to this card files contained on the disk 5.

The following programs have been prepared on the disk 5, and are ready to be downloaded onto the processor cards 3a to 3g.

an operating system,

a client part of the file transfer software,

a manager of external modules,

software for appending external system modules.

The latter appending software is designed and declared as first program to be executed by the operating system on startup thereof. Stated otherwise, it is the first task to be accomplished by the operating system once the latter has been started up.

With reference to FIG. 3, the manner of operation of the farm will now be described in the case of the insertion or extraction of a card.

The monitoring program 11 of the controller card continuously scans the state register 8.

When the card is powered up, for example when it is inserted into its location on the bus, the startup program 9 performs a few initializations of the card and of its registers, so as to allow it to communicate via the bus with other cards via read and write cycles in master/slave mode, that is to say by direct addressing of the memory areas of each card. The startup program then writes the value “DL” (boot request) to the state register 8.

The monitoring program 11 detects the value “DL” and triggers the boot program 12.

The monitoring program continues to scan the state registers 8 of all the cards.

The boot program 12 performs the writes in master/slave mode to the memory 10. The files are copied from the disk 5: operating system, client part of file transfer software, external modules manager and software for appending external system modules.

The boot program then starts the operating system of the card.

The operating system starts and executes firstly the appending program which is stored in the random access memory of the card.

The appending program boots the client part of the file transfer software.

In the controller card, the server part 13 of the same software transfers an external system module, which may for example be a network simulation module.

The appending program then starts the external modules manager so that the latter inserts the downloaded module into the operating system.

The card is thus started and automatically updated with the latest version of the operating system and of the system module.

Of course, the write and download operations described hereinabove may take place at any time and not solely following the insertion of the card into its location.

By virtue of the invention, the updating of the operating system and of the system modules in the card is performed automatically and with no risk of error or of omission by the operator.

If a module is revised, its updating in each of the cards takes place systematically, thereby guaranteeing the homogeneity of the processor cards of one and the same farm.

Individual administration of each processor card is thus no longer necessary.

The embodiment hereinabove is merely one example given so as to provide a clear understanding of the invention, which is in no way limited to the characteristics described with reference to this example.

1. A computer farm comprising a bus (7) and several processor cards (3a-3h) mounted on the bus, each processor card executing an operating system able to manage external system modules by way of drivers, which farm includes:
means (12) for writing, in a memory (10) of at least one processor card (3a), an operating system, a client part of a file transfer software, a manager of external modules and software for appending external system modules, this appending software being written as first program to be executed by the operating system upon startup thereof and having as tasks to start the client part of the file transfer software so as to download a system module, then to start the external modules manager so as to insert said downloaded module into the operating system,
means (12) for remotely starting the operating system of the processor card,
a server part (13) of the file transfer software for dispatching to the processor card, when requested by the client part when it is executed on said processor card, an external system module to be executed on the processor card.

2. The computer farm as claimed in claim 1, wherein the external system module is a simulator of a local network on the bus (7) between the processor cards (3a-3h) which are present on the bus, the writes to the memory of the card of the operating system, of the appending software and of the modules manager being performed by bus write cycles which are independent of the simulation of the network.

3. The computer farm as claimed in either one of claims 1 and 2, wherein the bus (7) is of PCI or CompactPCI type.

4. The computer farm as claimed in either one of claims 1 and 2, wherein the simulated local network is an Ethernet network
